(19) United States
(12) Patent Application Publication
(10) Pub. No.: US 2024/0101022 A1
(43) Pub. Date: Mar. 28, 2024

(54) ILLUMINATION SYSTEM FOR AN EXTERNAL CLADDING PART OF A MOTOR VEHICLE

(71) Applicant: Magna Exteriors GmbH, Sailauf (DE)

(72) Inventors: Johannes GOETZELMANN, Altertheim (DE); Klaus MUENKER, Griesstaett (DE); Michael WURSTER, Esslingen (DE); Tobias WEYER, Cologne (DE)

(21) Appl. No.: 18/370,455

(22) Filed: Sep. 20, 2023

(30) Foreign Application Priority Data
Sep. 28, 2022 (DE) 102022210250.9

(51) Int. Cl. B60Q 1/26; B32B 27/08; B32B 27/30; B32B 27/36; B60R 13/04; F21S 43/249

(52) U.S. Cl. CPC B60Q 1/26; B32B 27/08; B32B 27/308; B32B 27/365; B60R 13/04; F21S 43/249; B32B 2250/02; B32B 2250/24; B32B 2255/10; B32B 2307/4023; B32B 2307/41; B32B 2307/412; B32B 2605/08

(57) ABSTRACT

The invention relates to an illumination system (1) for an external cladding part of a motor vehicle, having at least a configuration region (2), which has a visible side facing towards the outer side and a rear side with a rear-side face (2b) as well as side faces (2a), wherein the configuration region (2) is formed as a light-guide body and is processed on the rear-side face (2b) in the region of a light window for representation of a characteristic feature appearing three-dimensionally on the visible side, having a housing element (4) with a coloured bottom face (4b) and side faces (4c), wherein an air gap remains between the rear-side face (2b) of the configuration region (2) and the bottom face (4b), and an installation space, in which a light source (6) is arranged, remains between the configuration region (2) and the side face (4c) of the housing element (2), the light being couplable into a side face of the configuration region (2) and being couplable out at the laser structure (11), and subsequently shining through the configuration region (2) on the outer side, wherein the light source (6) is covered or coverable by a colouring coating (3).

### CROSS-REFERENCE TO RELATED APPLICATIONS

This application claims priority to German Application No. DE 102022210250.9 filed on Sep. 28, 2022. The entire disclosure of the above application is incorporated herein by reference.

### FIELD OF THE INVENTION

The invention relates to an illumination system for an external cladding part of a motor vehicle, the external cladding part being in particular a front module.

### BACKGROUND OF THE INVENTION

This section provides information related to the present disclosure which is not necessarily prior art.

Owing to the increasing spread of electric vehicles, the requirements placed on front panels are changing since radiator inlet openings are not required to the same extent as for conventional motor vehicles equipped with internal combustion engines.

Front panels in electric vehicles are increasingly being provided with closed radiator claddings, which corresponds to better aerodynamics of the vehicle together with less requirement for cooling air.

Front panels may be manufactured from a transparent polycarbonate and provided with suitable decoration elements or functional elements, for example illumination modules. For this purpose, the front panels are produced according to the prior art by a two-component injection-moulding method. The rear side, that is to say the vehicle inner side of the three-dimensionally shaped front panel, is subsequently painted, while the front side, that is to say the outer side of the vehicle, needs to be protected against paint spray. To this end, the front side is masked. In order to produce multi-coloured structures, impressed geometries of the front panel are exposed using a laser. The inner side is subsequently coated by a physical vapour deposition method (PVD) in order to obtain a chrome effect together with light transparency. A hard paint coating is applied to the front side.

It is furthermore known to integrate separate components in the form of design elements, for example brand symbols, into the front panels. The components may be decorated with a chrome film and subsequently fitted into corresponding recesses of the moulded plastic parts painted with the colouration of the paint of the motor vehicle.

These decorated components, for example brand symbols, may be illuminated from the rear side by the use of light-transmitting materials and therefore form a decorative illumination function. However, such known cladding elements with integrated light functions have the disadvantage that the illumination is visible to a user even in the unilluminated state and is only decorative, and does not provide functional illumination.

### SUMMARY OF THE INVENTION

This section provides a general summary of the disclosure, and is not a comprehensive disclosure of its full scope or all of its features.

It is an object of the invention to provide an illumination system for an external cladding part having a coloured visible side, the colour preferably being the body colour, for a motor vehicle, wherein at least in a first state it imparts a visually uniform configuration to a user as seen from the outer side of the motor vehicle and a three-dimensional characteristic feature is not visible, and wherein in a second state the three-dimensional characteristic feature is visible as seen from the outer side and the visible side is furthermore perceptible as a uniformly coloured surface overall.

The object is achieved by an illumination system for an external cladding part comprising:
a configuration region having a visible side facing towards the outer side and a rear side with a rear-side face as well as side faces, the configuration region being formed as a light-guide body from a transparent thermoplastic material which is suitable for laser engraving, for example a PMMA, the configuration region forming a light window and being processed by means of a laser structure on the rear-side face or by means of local structures inside the configuration region for individual adaptation of the vehicle and/or for the representation of a characteristic feature appearing three-dimensionally on the visible side;
a housing element having a trough-shaped recess with a bottom face and side faces, the bottom face being provided with a colouring coating,
wherein the configuration region is attached to the housing element in such a way that the configuration region is enclosed at least by a rear-side section of the recess and an air gap remains between the rear-side face of the configuration region and the bottom face, and that an installation space remains between at least one side face of the configuration region and a side face of the housing element; and
at least one light source arranged in the at least one installation space, the light source being couplable into at least one side face of the configuration region and being couplable out in the further beam path at the laser structure, and subsequently shining through the configuration region on the outer side in order to generate the three-dimensional characteristic feature,
wherein the at least one light source is covered or coverable in the installation space by a colouring coating.

By virtue of the illumination system according to the invention of an external cladding part, it is possible to produce a configuration region having at least one three-dimensionally appearing characteristic feature with a “secret until lit” function. This means that in a first state this characteristic feature is not visible to a user and the user has the impression of a uniformly coloured external cladding part. In a second state, the three-dimensionally appearing characteristic feature is visible to a user from the outer side. In this second state, the user perceives the configuration region on the visible side with the three-dimensionally appearing characteristic feature of the vehicle manufacturer and/or decorative and/or informative elements such as at least one symbol, a number, an image, a brand symbol together with the colouring coating as a background.

This uniform appearance of the visible side, that is to say the colouring coating, may be produced by painting or a paint film. The colouring coating is opaque.

By virtue of the illumination system according to the invention, it is possible to provide the user of a motor vehicle and/or a road user at least temporarily with different illuminated features. These features may involve both safety-relevant aspects and possibilities for communication by illuminated symbols or lettering. The features may also involve design features. In this way, an extension of the functional possibilities of illuminated front panels is achieved. For example, the indicator light function may be envisaged as a further integratable function.

An advantage in this case is the cover layer or cover element, forming the front side uniformly of the external cladding element, which as a transparent moulded plastic part comprises or covers the light window and the configuration region so that there are no seams in the surface region of the illumination system in the installed situation on the cladding part. In this way, in particular, sealing problems in the integration of the illuminated features are avoided.

In a particularly preferred embodiment, the colouring coating of the opaque region of the cover element is in this case the same colour as the colouring coating of the housing element, this colour corresponding to the body colour of the motor vehicle.

The outer side or visible side is considered to be the surface region visible to a user from the external surroundings. The inner side is correspondingly the opposite side from the outer side, facing towards the inner side.

A cladding part illuminable in transmission is considered in particular to be an external cladding part, for example a front panel, a bumper cladding, a boot lid cladding, a door cladding, a roof cladding or a spoiler, or a component of one of the aforementioned parts.

The external cladding part is three-dimensionally designed.

The illumination function is produced by at least one light source. One or more LEDs may be used as the at least one light source. The light source or light sources are respectively arranged behind the intended visible side in the region of the opaque section of the cover element, or of the cover layer.

The at least one light source is in this case arranged in such a way that it couples its light laterally into a light input coupling region of the configuration element, which acts as a light-guide body.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a sectional image of a structure of an illumination system in a first embodiment; and

FIG. 2 shows a sectional image of a structure of an illumination system in a second embodiment.

### DESCRIPTION OF THE INVENTION

The illumination system according to the invention for an external cladding part of a motor vehicle is described below with the aid of an illumination system of a front panel as an external cladding part in the front region of an electric vehicle. Of course, such an external cladding part may also be used as a cladding element at any other desired place on a motor vehicle. The external cladding part may preferably also be a bumper cladding, a boot lid cladding, a door cladding, a roof cladding or a spoiler, or is a component of one of the aforementioned parts.

An illumination system 1 of the external cladding part is shown in the drawings in a schematic sectional representation and has a front side (V) and a rear side (R). The front side V is the visible side of the outer shell of the motor vehicle in the intended installation situation on the motor vehicle and is visible to a user.

The illumination system 1 generally includes a configuration region 2, a housing element 4 and at least one light source 6.

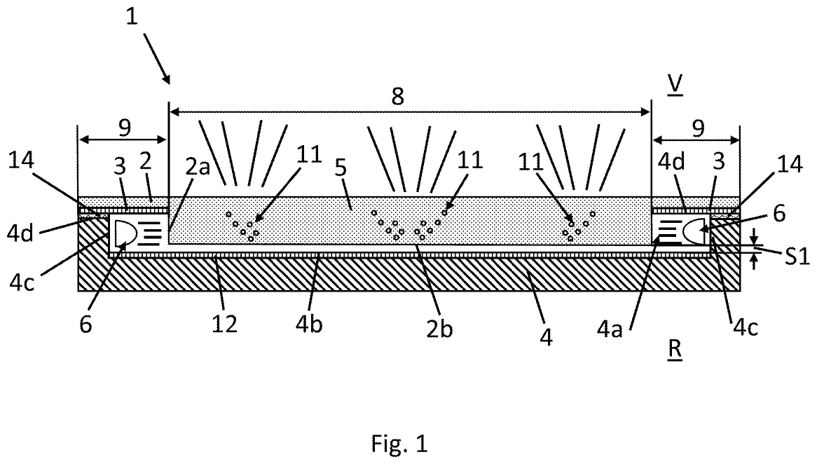

In the embodiment shown in FIG. 1, the configuration region 2 is designed as a cover element 5 which has a transparent or translucent light window 8 and at least one opaque section 9 having a colouring coating, or is designed to be colouring.

The cover element 5 is formed as a composite plastic component and comprises a deep-drawn three-dimensionally designed decoration carrier 3 and at least one externally arranged transparent cover layer. The decoration carrier 3 is a plastic film, in particular a transparent plastic film, which has a coloured coating/painting. The painting corresponds in terms of colouration to the painting of the motor vehicle. The painting or coating is not provided in the region which forms the light window 8.

Alternatively, the decoration carrier 3 may be a coloured paint film, with the light-transmitting region being produced as stamping of the decoration carrier 3.

The film as the decoration carrier 3 is back-injection-moulded with a transparent polymer material by an injection-moulding method. In the embodiment shown in FIG. 1, the transparent polymer material is a polymethyl methacrylate (PMMA). In the region of the light-transmitting region of the decoration carrier 3, the light window 8 is correspondingly formed in the cover element. The transparent cover layer forms the front side of the cover element.

As may be seen in FIG. 1 for the first exemplary embodiment, the configuration region 2, which is likewise moulded on during the injection-moulding method, is formed on the cover element in the region of the transparent light window 8. The aforementioned material used is a synthetic, hyaloid thermoplastic which is hot-formable. This plastic is ideally suited for laser cutting and engraving with CO2 lasers.

The configuration region 2 comprises side walls 2a and a rear-side face 2b. The rear-side face 2b is treated with the aid of a laser. During the laser engraving of acrylic/PMMA/PC, the surface is ablated with the aid of the laser to form an external engraving. Even very fine details may thus be represented accurately by laser engraving on acrylic. The result on pellucid acrylic is matt-white engraving 11, which may be used to represent a characteristic feature of the vehicle manufacturer and/or decorative and/or informative elements such as at least one symbol, a number, an image, a brand symbol, for example a logo.

In a further embodiment, the interior of the configuration region 2 is formed with local structures 11 in the region of the light window 8. These local structures 11, represented by small circles in FIG. 1, serve to display a characteristic feature of the vehicle manufacturer and/or decorative and/or informative elements such as at least a symbol, a sign, an image, a brand symbol, for example a logo, should the configuration region in the form of a light-guide body be illuminated. The local structures 11 in the interior are likewise produced by means of laser-induced material modification.

The local structures or engraving 11 by means of a laser generates a three-dimensional structure in the form of external engraving, but this does not modify the front side and smooth outer shell of the cover in the region of the light window 8. The structure therefore remains protected against wear, and the surface on the front side remains smooth and unprocessed. The term unprocessed in this context indicates only that the surface on the front side of the cover element is not structured by a laser. The surface remains smooth and merely follows a predetermined contour, if required.

The illumination system 1 furthermore comprises the housing element 4, which has a trough-shaped recess 4a with a bottom face 4b and side walls 4c. The bottom face 4b and the side walls 4c delimit the recess, which is open upwards. The bottom face 4b furthermore has end faces 4d directed towards the front side.

The housing element 4 is designed with a colouring coating 12 at least in the region of the bottom face. The colouring coating 12 corresponds in terms of colour to the colouring coating 12 of the cover element and is preferably the body colour of the motor vehicle (the colour code of the colouring coatings is the same as the colour code of the car paint). The housing element 4 is produced from a thermoplastic material such as a polycarbonate (PC) or acrylonitrile butadiene styrene (ABS). The colour coating is produced by conventional methods such as a coating method or a film lamination method.

As may be seen from the sectional representation, the cover element 5 is placed on the housing element 4 in such a way that the configuration region 2 projects with its height-wise extent fully into the trough-shaped recess 4a and is enclosed by all side walls 4c of the housing element 4. The cover element 5 is held fixed on the end sides 4d of the housing element 4 by means of an adhesive bond 14, for instance an adhesive tape.

An air gap S1 in this case remains between the rear-side face 2b of the configuration region 2 and the bottom face 4b of the housing element.

An installation space likewise remains between two side walls 2a of the configuration region and the respectively correspondingly opposite side walls 4c of the housing element 4.

In order to make the above-described structure of the configuration region visible from the outer side, illumination is provided. As may be seen in FIG. 1, at least one lighting means 6 is arranged in each installation space. The lighting means 6 are in this case arranged with an alignment such that the emitted light is coupled into the side walls 2a, or into input coupling faces of the side walls of the configuration region 2, which serves as a light-guide body. The light thereby coupled into the configuration region 2 is coupled out and directed further on at the previously processed structured rear-side face 2b, and emitted through the configuration region 2 and the light window 8 towards the outer side, so that the characteristic feature is visible on the outer side in the region of the light window 8. The light rays are symbolically represented by the lines.

The characteristic feature may also comprise illuminated symbols, letters, characters, brand emblems, which appear and are visible from the outer side in the second state.

As may furthermore be seen from the schematic representation of FIG. 1, the lighting means 6 are arranged in the laterally represented installation spaces so as to be concealed as seen from the outer side by the colouring coating of the cover element 5. The illumination system 1 is furthermore dimensioned and designed in such a way that the bottom face 4b of the housing element 4 is provided with the same colouring coating over the entire width and fully covers the light window 8 and at least a portion of the opaque section of the configuration region as seen from the rear side. By this embodiment, in the first state a uniform continuous appearance, preferably in the body colour, is visible as seen from the outer side. This is also referred to as a “secret until lit” function. In the second state, a three-dimensionally appearing characteristic feature of the vehicle manufacturer and/or decorative and/or informative elements, such as at least one symbol, a sign, an image or a brand symbol, is back-lit on the visible side and the colouring coating continues to be perceptible as a background.

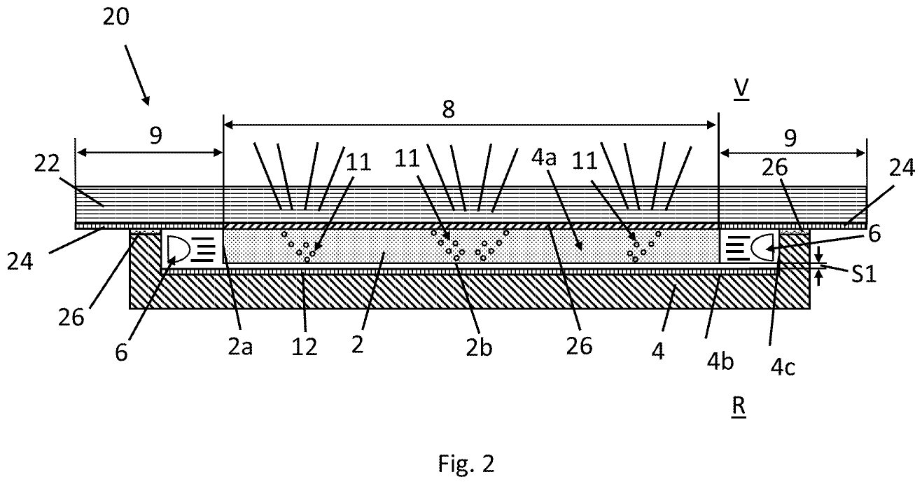

FIG. 2 shows an illumination system 20 in which, in contrast to the embodiment previously described, a configuration region 2 is produced as a separate plastic plate of a transparent polymer material, a polymethyl methacrylate (PMMA). As an outer covering, there is a cover layer 22 of a transparent plastic material consisting of a polycarbonate. The cover layer 22 comprises an opaque region 24 with a colouring coating and a clear transparent or translucent light window, which is designed in accordance with the light window 8 of the configuration region 2 and correspondingly covers the latter in the mounted situation.

The cover layer 22 comprises a rear-side decoration carrier, which generates the colouring coating in the opaque region.

The configuration region 2 as a separate plastic plate with rear-side laser engraving in order to generate the three-dimensional characteristic features is bonded by means of an optically transparent adhesive 22 onto the rear side of the cover element 22 in the region of the light window.

The further configuration of the housing element 4, of the illumination 6 and of the assembly corresponds to the description relating to FIG. 1.

What is claimed is:

1. An Illumination system for an external cladding part of a motor vehicle, comprising:
a configuration region having a visible side facing towards the outer side and a rear side with a rear-side face as well as side faces, the configuration region being formed as a light-guide body from a transparent thermoplastic material which is suitable for laser engraving, for example a PMMA, the configuration region forming a light window and being processed by means of a laser structure on the rear-side face or by means of local structures inside the configuration region for individual adaptation of the vehicle and/or for the representation of a characteristic feature appearing three-dimensionally on the visible side;
a housing element which has a trough-shaped recess with a bottom face and side faces, the bottom face being provided with a colouring coating, wherein the configuration region is attached to the housing element in such a way that the configuration region is enclosed at least by a rear-side section of the recess and an air gap remains between the rear-side face of the configuration region and the bottom face, and that an installation space remains between at least one side face of the configuration region and a side face of the housing element; and
at least one light source arranged in the at least one installation space, the at least one light source being couplable into at least one side face of the configuration region and being couplable out in the further beam path at the laser structure, and subsequently shining through the configuration region on the outer side in order to generate the three-dimensional characteristic feature,
wherein the at least one light source is covered or coverable in the installation space by a colouring coating.

2. The illumination system according to claim 1, wherein the configuration region is designed as a cover element which has the configuration region in the form of the at least one light window and at least one opaque section with a colouring coating, this opaque section concealing the at least one light source in the installation space from the visible side.

3. The illumination system according to claim 1, wherein a plastic layer as a cover layer is furthermore formed from a thermoplastic material, preferably a polycarbonate, the cover layer having an opaque region with a colouring coating and a clear transparent or translucent light window which is designed so as to correspond with the light window of the configuration region and correspondingly covers the latter, the configuration region and the cover layer being connected by means of a transparent optical adhesive and the at least one light source being covered by the colouring coating of the cover layer from the visible side.

4. The illumination system according to claim 1, wherein the colouring coating of the cover layer, or the colouring coating of the cover element, and the colouring coating of the housing element are designed with the same colour, preferably the body colour.

5. The illumination system according to claim 1, wherein the colouring coating is a coloured light-transmitting film or painting or a coloured component.

6. The illumination system according to claim 1, wherein the at least one light source is one of more LEDs or a light strip.

7. The illumination system according to claim 1, wherein the housing element is attached to the external cladding element or is formed integrally with the external cladding element.
